(19) United States
(12) Patent Application Publication
(10) Pub. No.: US 2026/0253113 A1
(43) Pub. Date: Aug. 27, 2026

(54) SYSTEMS AND METHODS FOR CONVERTING DIGITAL HEALTH ACTIVITES INTO BILLABLE EVENTS

(71) Applicant: Solera Health, Inc., Phoenix, AZ (US)

(72) Inventors: Byron Crowe, Boston, MA (US); Shaun Hardin, Worthington, OH (US); Benjamin Henderson, Dickson, TN (US); Jennifer Mary Houser, Camden, ME (US); Mary Langowski, Chicago, IL (US); Edward George Liebowitz, Madison, NJ (US); Adam Smeal, Buckeye, AZ (US); Jody Spusta, Pewaukee, WI (US)

(73) Assignee: Solera Health, Inc., Phoenix, AZ (US)

(21) Appl. No.: 19/545,283

(22) Filed: Feb. 20, 2026

Related U.S. Application Data
(60) Provisional application No. 63/761,840, filed on Feb. 21, 2025.

(51) Int. Cl. G06Q 30/04

(52) U.S. Cl. CPC G06Q 30/04

(57) ABSTRACT

Systems and methods for converting digital health activities into billable events to improve the efficiency of managing digital health activities are introduced. The disclosure provides a platform comprising a memory and processor configured to receive new health activity data from participant devices, retrieve associated healthcare data sets, and map the new activity data into the healthcare data sets in standardized formats using transformation algorithms. The systems and methods validate data schema and content, integrate past and new activity data, and evaluate combined data against milestone templates to identify observed activity patterns associated with billable events. Upon detection, the systems and methods generate electronic records and billing instructions in accordance with interoperability standards and output billing instructions to secondary systems for claims processing and partner payouts.

### CROSS REFERENCE TO RELATED APPLICATION

This application claims the benefit of priority of U.S. Provisional Patent Application No. 63/761,840, filed on Feb. 21, 2025, the entire contents of which are incorporated herein by reference.

### TECHNICAL FIELD

The present disclosure generally related to systems and methods for converting digital health activities into billable events, and more particularly, to systems and methods for transforming digital health activities into billable clinical charge codes and reimbursable claims to improve the efficiency of managing digital health activities.

### BACKGROUND

Digital health ecosystems generate heterogeneous, asynchronous digital health activity data from various devices, applications, and other technical platforms. Such data are often discontinuous. These data arrive as disparate schemas and file types and lack a unified, canonical representation. Thus, when managing digital healthcare, healthcare providers are faced with managing increasingly fragmented, complex, and costly systems to identify, segment, and classify sequences of digital health activities as billable events suitable for downstream reimbursement. Healthcare payers and providers often find themselves managing a multitude of independent and siloed point solutions, each designed to address specific health issues or conditions such as weight loss or diabetes. For example, there may be a healthcare solution that focuses on digestive health needs and there may be another independent solution that helps with managing hypertension. If a patient with hypertension is also having digestive problems and wants to get better by managing her health altogether, she would have to manage these two point solutions separately. While these solutions may be effective individually, they pose challenges in terms of service delivery and reimbursement when they are integrated into a broader healthcare strategy of a patient. The challenge of managing individual point solutions is amplified by the volume, variety, and velocity of incoming data. The incoming data may frequently contain inconsistent field semantics, missing metadata, out-of-range values, and duplicates. Without automated pipelines for managing various point solutions, healthcare stakeholders cannot continuously assess the performance or relevance of each solution at scale. Additionally, there is a need to determine when accumulated digital health activities across multiple sources constitute a clinically meaningful milestone that can be billed. For example, proprietary criteria may define that a combination of coach sessions, exercise minutes, weigh-ins over a defined time period, and any other health activity equals a reimbursable milestone. Identifying these patterns and converting them into billable events requires automated detection logic, which is more than mere data aggregation.

Managing multiple point solutions separately requires substantial administrative and technical resources. With multitude of contracted point solutions available, managing them efficiently while ensuring maximum utilization is not easy for individuals or even for big healthcare payers or providers (e.g., employers). For example, managing multiple point solutions separately may require processing of voluminous data in different formats and distinct engagement models. Also, there may be a lack of standardized mechanisms for tracking progress, outcomes, or billing activities. When an employer has to manage hundreds of point solutions for its employees, greater computational memory allocation for the employer's storage systems is required to store, send, and process these voluminous data.

Managing a multitude of independent and siloed point solutions leads to several issues for healthcare payers and providers. For example, managing a variety of independent vendors creates challenges in ensuring the accountability of each solution in terms of both cost-effectiveness and health outcomes. The inefficiencies introduced by managing multiple solutions contribute to escalating healthcare costs. The administrative burden associated with maintaining these separate solutions (e.g., claims processing to compliance, tracking consumer engagement, assessing patient progress, etc.) drives up overhead costs. This burden is further exacerbated when an organization that manages hundreds of point solutions has to manage financials for each point solution separately (e.g., billing each vendor, identifying type of payment, etc.). It is often difficult to compare and assess the effectiveness of various healthcare programs across multiple point solutions. This lack of visibility into the performance makes it challenging for healthcare payers and providers to determine which programs are delivering the best outcomes, further exacerbating the inefficiency and wasted resources in the healthcare system. The conventional method of researching, managing, and evaluating point solutions separately is inefficient and ineffective.

In digital health, there is frequently no traditional medical record, and many interventions lack standardized CPT codes or agreed-upon criteria for assessing progress and completion. This creates a technical challenge for systems to identify when a sequence of digital health activities constitutes a clinically meaningful event and to automatically map such events to recognized billing codes. The absence of standardized data models and automated detection mechanisms makes it difficult for computing systems to convert heterogeneous, asynchronous digital health activity data from various streams into structured, billable records. Conventional systems fail to support claims-based reimbursement or pay-for-performance frameworks in digital health. Conventional systems also face a fundamental challenge in distinguishing clinically meaningful digital engagement from routine data collection. Conventional health data-aggregation systems such as standard EHR platforms typically record events or measurements without evaluating whether those health activities satisfy clinically defined engagement criteria. As a result, such systems treat digital activity as generic data rather than as evidence of clinical progress.

Digital health programs also do not easily align with conventional event-based billing models. Traditional reimbursement requires a specific medical code supported by documentation in a traditional medical record confirming that a clinical encounter occurred. In digital health, however, the absence of a traditional medical record and the lack of standardized medical codes for many modalities make it unclear what constitutes a billable clinical event. Categories of evidence-based digital interventions, including intensive behavioral counseling (IBC), internet-based cognitive behavioral therapy (iCBT), virtual physical therapy (vPT), and self-monitored blood pressure (SMBP), are not reflected in conventional event-based billing models, leaving digital health organizations without a clear mechanism to convert participant activities into reimbursable claims. This gap creates challenges for digital health companies delivering evidence-based interventions but lacking a defined pathway to generate billable events under the traditional healthcare billing model.

The absence of standardized billing pathways for digital health creates operational, technical, and financial barriers for payers and providers alike. There is a need for systems and methods that define clinically meaningful digital engagements, group them into structured billable events or milestones, and associate those with appropriate billable clinical charge code to enable claims-based and/or performance-based reimbursement and payment models.

In light of these challenges, there is a need to provide a more efficient and effective way to managing digital healthcare. Accordingly, it is desirable to develop systems and methods for converting digital health activities into billable events.

### SUMMARY

Embodiments of the present disclosure may provide a memory storing instructions that, when executed by at least one processor, cause the at least one processor to perform operations for managing digital health activities. The instructions may comprise receiving, from a participant device, a new health activity data for a participant. The instructions may further comprise retrieving a healthcare data set associated with the participant, wherein the healthcare data set includes a participant identifier and past health activity data associated with the participant. The instructions may further comprise mapping the new health activity data into the healthcare data set, wherein the mapping comprises validating data schema, field content, and a data range of the new health activity, converting, using at least one transformation algorithm, the new health activity data into a standardized format to enable interoperability, and loading the converted new health activity data into the healthcare data set to generate combined health activity data including the past health activity data and the converted new health activity data. The instructions may further comprise determining, by evaluating the healthcare data set against a library of milestone templates, whether the combined health activity data in the healthcare data set leads to an observed activity pattern associated with a billable event. The instructions may further comprise, if the combined health activity data in the healthcare data set leads to the observed activity pattern, converting the observed activity pattern into an electronic record, generating a billing instruction associated with the electronic record, and outputting the generated billing instruction to a secondary system.

According to an embodiment of the present disclosure, the healthcare data set further includes a health program associated with the participant, eligibility associated with the participant, a group configuration associated with the participant, enrollment associated with the participant, or a health program contract associated with the participant.

According to an embodiment of the present disclosure, the generated billing instruction includes a charge identification, a charge amount, and a medical classification code.

According to an embodiment of the present disclosure, outputting the generated billing instruction further comprises associating the charge identification and the healthcare data set, generating a claim object, the claim object comprising data elements extracted from the healthcare data set and the generated billing instruction, publishing the claim object to a third-party payer system, monitoring whether the charge amount has been received by the third-party payer system, and initiating, upon confirmation of receipt of the charge amount, a payout process to a network partner system.

According to an embodiment of the present disclosure, determining whether the combined health activity data in the healthcare data set leads to an observed activity pattern associated with a billable event further comprises retrieving milestone achievement criteria associated with a plurality of milestone templates in the library of milestone templates, each milestone template being stored as a data structure associated with a health program contract associated with the participant, assessing, using a rule-based assessment engine, the combined health activity data in the healthcare data set against the plurality of milestone templates by mapping the retrieved milestone achievement criteria against the healthcare data set, determining, based on the assessing, whether the milestone achievement criteria in at least one milestone template have been satisfied, and if the milestone achievement criteria have been satisfied generating a milestone object, the milestone object comprising metadata linking the combined health activity data and the healthcare data set and updating a satisfaction status associated with the milestone object.

According to an embodiment of the present disclosure, the generated billing instruction is a standardized electronic claim formatted according to the EDI-837 specification.

According to an embodiment of the present disclosure, the standardized format to enable interoperability comprises a Fast Healthcare Interoperability Resources (FHIR) framework.

According to an embodiment of the present disclosure, the secondary system comprises a third-party payer system and a network partner system.

According to an embodiment of the present disclosure, the instructions further comprise to utilize an external interface configured to enable retrieval of participant information and submission of the new health activity data for processing.

According to an embodiment of the present disclosure, the external interface is configured to enforce security protocols prior to accepting the new health activity data.

According to an embodiment of the present disclosure, the mapping further comprises utilizing a network-partner-specific mapping module configured to support data elements and formats associated with the network partner.

According to an embodiment of the present disclosure, the mapping further comprises converting network-partner-specific health activity names into standardized health activity names according to a canonical data model.

According to an embodiment of the present disclosure, upon determining that the combined health activity data in the healthcare data set leads to the observed activity pattern, the processor is configured to execute the instructions to generate a milestone object and a charge item based on the observed activity pattern, the milestone object and charge item being formatted in accordance with the Fast Healthcare Interoperability Resources (FHIR) framework.

Embodiments of the present disclosure may provide a method for managing digital health activities. The method may comprise receiving, from a participant device, a new health activity data for a participant. The method may further comprise retrieving a healthcare data set associated with the participant, wherein the healthcare data set includes a participant identifier and past health activity data associated with the participant. The method may further comprise mapping the new health activity data into the healthcare data set, wherein the mapping comprises validating data schema, field content, and a data range of the new health activity, converting, using at least one transformation algorithm, the new health activity data into a standardized format to enable interoperability, and loading the converted new health activity data into the healthcare data set to generate combined health activity data including the past health activity data and the converted new health activity data. The method may further comprise determining, by evaluating the healthcare data set against a library of milestone templates, whether the combined health activity data in the healthcare data set leads to an observed activity pattern associated with a billable event. The method may further comprise, if the combined health activity data in the healthcare data set leads to the observed activity pattern, converting the observed activity pattern into an electronic record, generating a billing instruction associated with the electronic record, and outputting the generated billing instruction to a secondary system.

The systems and methods disclosed herein may be used in various applications and business systems. It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 is a block diagram illustrating an exemplary application of a digital health management system, consistent with disclosed embodiments.

FIG. 2 is a block diagram illustrating an exemplary digital health management system, consistent with disclosed embodiments.

FIG. 3 is a block diagram illustrating an exemplary payer and network partner data integration of digital health management system, consistent with disclosed embodiments.

FIG. 4A is a block diagram illustrating an exemplary participant commitment, consistent with disclosed embodiments.

FIG. 4B is a block diagram illustrating an exemplary participant enrollment, consistent with disclosed embodiments.

FIG. 4C is a block diagram illustrating an exemplary participant health activity, consistent with disclosed embodiments.

FIG. 5 is a block diagram illustrating an exemplary data conversion process of digital health management system, consistent with disclosed embodiments.

FIG. 6 is a block diagram illustrating an exemplary participant data integration for billing process of digital health management system, consistent with disclosed embodiments.

FIG. 7 is a flow diagram illustrating an exemplary method of converting digital health activity data into a charge item for billing, consistent with disclosed embodiments.

FIG. 8 is a block diagram of an exemplary computing device that may be employed in connection with disclosed embodiments.

### DETAILED DESCRIPTION

Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present exemplary embodiments of the invention, examples of which are illustrated in the accompanying drawings. Wherever possible, the same reference numbers will be used throughout the drawings to refer to the same or like parts.

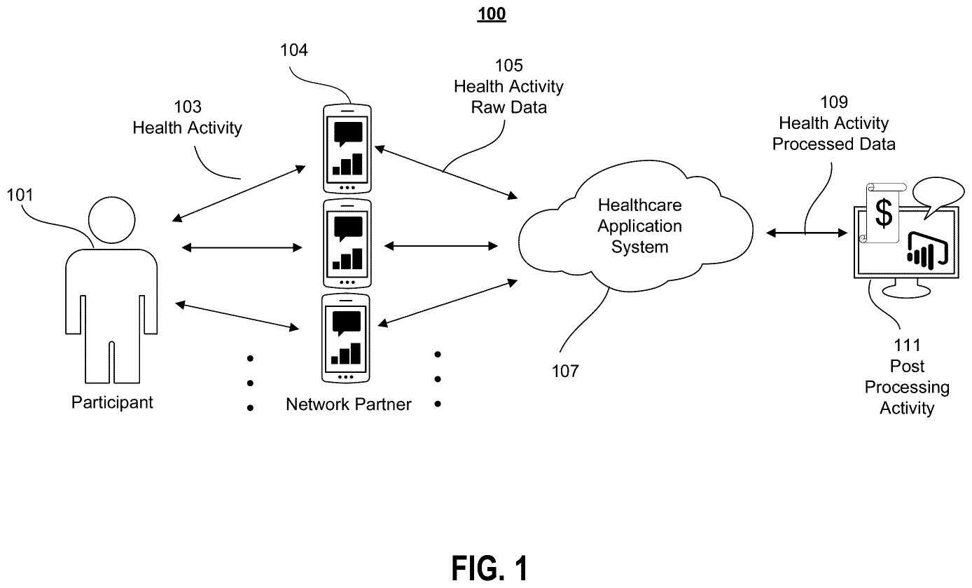

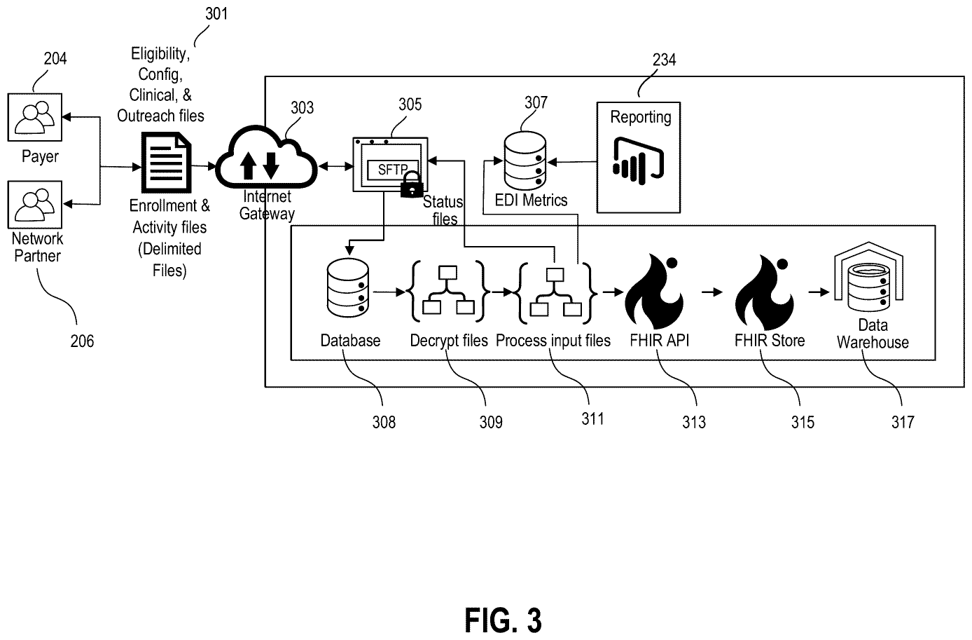

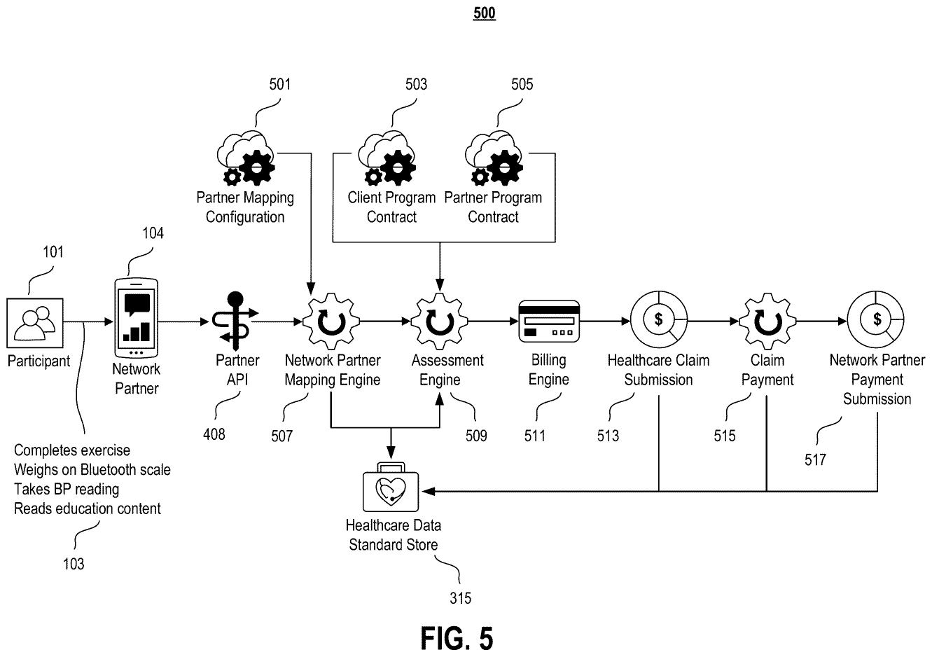

FIG. 1 is a block diagram illustrating a situation involving participant 101 engaging in a health activity 103 and sending health-related data to a healthcare application system 107 via network partners 104 for post processing activity 111. Healthcare application system 107 may provide a central platform for managing digital healthcare. A central platform may refer to any hardware and/or software hosting a web application infrastructure which allows the application to run. In some embodiments, healthcare application system 107 may provide an application programming interface (API) to network partner entities, offering point solutions for managing various health conditions. In such embodiments, participant 101 may initially transmit health activity data to a network partner 104 system through the API and subsequently deliver the data to healthcare application system 107 for further processing and analysis. Participant 101 may engage in a new health activity, resulting in the generation of health activity data 103. This new health activity data may eventually be received by healthcare application system 107 and be associated with participant 101. Healthcare application system 107 may maintain a repository of past health activity data for each participant. Such past data may have been previously collected and stored by healthcare application system 107. Upon receipt of the new health activity data, healthcare application system 107 may retrieve a corresponding healthcare data set for participant 101, which may comprise both the newly received activity data and the historical health activity data. Healthcare application system 107 may be configured to process and integrate the new health activity data with the existing data set, thereby enabling comprehensive tracking and analysis of participant health activities over time. The integration of the new health activity data into the existing data set may generate combined health activity data, which provide comprehensive health activity data for participant 101. The integration process of combining the new health activity data into participant 101's past health activity data may transform fragmented, source-specific health activity data into a unified representation that reflects participant 101's health-related engagement across multiple programs. Rather than treating each discrete health activity event in isolation, healthcare application system 107 may interpret sequences of related activities as a single clinically meaningful milestone. By aggregating and normalizing data into canonical sequence objects, healthcare application system 107 may create a foundation for consistent milestone evaluation and reproducible billing logic. In some embodiments, “combined health activity data” may refer to a standardized representation produced by a multi-stage process that validates data schema, field content, and permissible ranges to normalize heterogeneous data formats. Healthcare application system 107 may further aggregate events to construct objects that capture ordered, observed activity patterns across sources. Healthcare application system 107 may store the combined health activity data for participant 101 to support consistency and reproducibility for milestone evaluation and billing. This integration may facilitate subsequent internal operations, including data mapping via network partner mapping engine 507, milestone evaluation through assessment engine 509, and billing event determination via billing engine 511 for post processing activity 111, each discussed below with respect to at least FIG. 5. In some embodiments, healthcare application system 107 may classify a participant's health activities according to health program-specific clinical criteria to surface clinically meaningful engagement. This is different from generic health activity patterns; unlike conventional electronic health record (EHR) systems that generate claims based on documented in-person encounters, healthcare application system 107 may apply milestone templates (discussed below with respect to at least FIG. 3) that encode clinically significant digital engagement requirements and may evaluate whether aggregated intervention-specific health activities satisfy those requirements. Healthcare application system 107 may determine when a participant 101's digital health activities collectively constitute a billable milestone, rather than treating each health activity as an isolated or routine event.

Participant 101 may include an individual, an employee under employer's insurance plan, an individual insurance plan purchaser, a union member under union's insurance plan, or any other individual that may engage in digital health activity 103. In some embodiments, participant 101 may be referred to as a “member,” whose healthcare benefits are insured, administered, or otherwise managed by a payer. Participant 101 may access healthcare application system 107 by a participant computing device. The computing device may be a mobile device, desktop, laptop, tablet, virtual/augmented reality (VR/AR) device, or any other device capable of accessing healthcare application system 107. In some embodiments, participant 101 may access healthcare application system 107 indirectly through one or more connected point solution systems that interface with healthcare application system 107 via an API or other communication mechanism. The payer may include an employer, a union, a state or federal government agency, or any other entity that sponsors digital healthcare management. In such embodiments, members may satisfy one or more eligibility criteria to be eligible for digital health program services providing management of variety of health conditions, including diabetes, digestive health issues, hypertension, mental health issues, musculoskeletal (MSK) issues, tobacco use problems, weight management, and women's health.

Health activity 103 may be an exercise, blood sugar level monitoring, behavioral therapy, counselling, meditation, or any other physical and/or mental activities that an individual may perform for managing one's health. Health activity 103 may refer to physical action or engagement by participant 101 that will generate health activity data for post processing activity 111. In some embodiments, health conditions that an individual manages may be diabetes management, weight management, hypertension, mental health, women's health, tobacco cessation, digestive health and musculoskeletal (MSK), or the like. In some embodiments, health activity 103 may include structured engagements, assessments, or therapeutic interactions delivered through third party partner systems, which may produce data indicative of participant progress or clinical relevance.

In some embodiments, health activity 103 may arise from evidence-based digital interventions that constitute clinically recognized treatment modalities delivered digitally, such as intensive behavioral counseling (IBC), internet-based cognitive behavioral therapy (iCBT), self-monitored blood pressure (SMBP), and virtual physical therapy (vPT). These digital interventions may generate discrete, clinically meaningful data points that the system evaluates as potential meaningful engagements within a milestone framework. For example, participant 101 may complete coaching sessions as part of an IBC-based weight-management program. In another example, participant 101 may record home blood pressure readings consistent with an SMBP protocol for a hypertension-management program. Such intervention-specific health activities may be captured, normalized, and mapped into healthcare application system 107 to support milestone determination, observed activity-pattern analysis, and conversion into billable events.

Network partner 104 may refer to an external entity or system that provides digital health solutions and transmit digital health activity data to healthcare application system 107 through a secure communication interface. Network partner 104 may deliver one or more point solutions, each designed to address a specific health condition such as diabetes, hypertension, or weight management. In some cases, network partner 104 may focus on a single point solution for managing a particular condition, while in other cases, the partner may offer multiple point solutions that address a range of health needs. In some embodiments, network partner 104 may be third-party health applications, wearable device providers, or service vendors that generate patient engagement data and transmit it for processing and conversion into billable events.

When participant 101 engages in health activity 103, a participant device may generate corresponding health activity raw data 105. Health activity raw data 105 may refer to unprocessed, event-level information associated with health activity 103. The participant's device or a connected network partner 104 may transmit this raw data to healthcare application system 107 for collection and processing. For example, when participant 101 uses a digital scale prior to or following an exercise session, the scale may record the weight measurement and send it through a partner application to healthcare application system 107. In another example, health activity raw data 105 may include step count data from a wearable activity tracker, heart rate measurements from a heart rate monitor, blood glucose readings from a glucose sensor, or any other responses to a digital behavioral health assessment. The devices for collecting such health data may transmit these data via APIs or network partner platforms to healthcare application system 107.

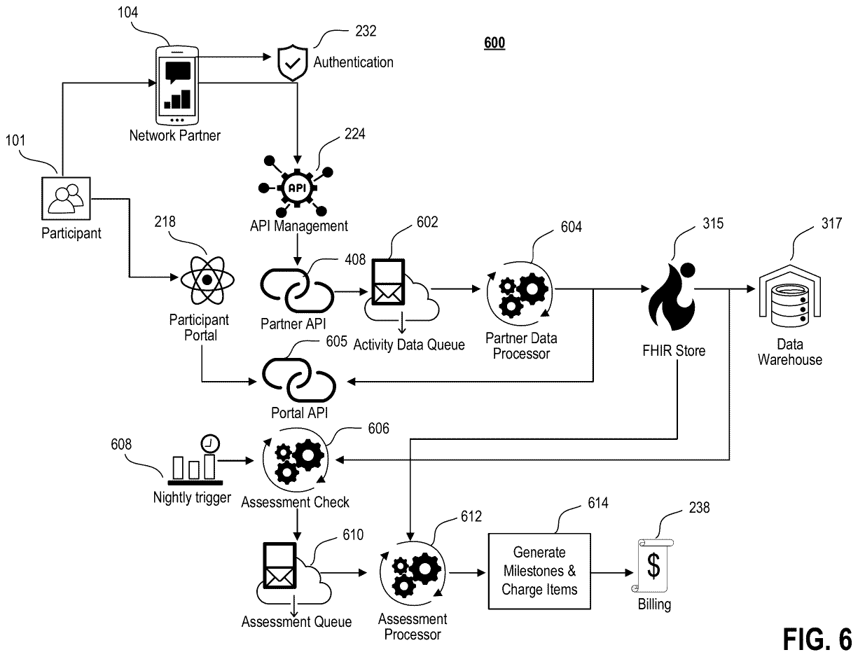

Healthcare application system 107 may process these collected data by converting health activity raw data 105 into health activity processed data 109. In some embodiments, the conversion from health activity raw data 105 into health activity processed data 109 may involve transforming health activity event-level data into a structured, canonical format suitable for downstream operations. For example, network partner-provided data may include key input data elements such as a unique identifier for the participant-program relationship, associated program identifiers, a network-partner-provided unique activity identifier, a timestamp for activity occurrence, activity name, an activity value (e.g., “30 minutes” for running), or the like. Healthcare application system 107 may normalize these heterogeneous inputs into a standardized schema by mapping various activity names from network partners to system-defined canonical activities. This mapping may ensure consistency across multiple network partners and enables accurate milestone evaluation. In other embodiments, healthcare application system 107 may convert structured network partner data into other structured data formats (e.g., FHIR-compliant data objects). For example, when a milestone is detected, healthcare application system 107 may create a ChargeItem FHIR object populated with billing attributes including milestone identifier, timestamp, charge amount, and associated CPT or ICD-10 codes derived from participant's healthcare provider contract terms. Healthcare application system 107 may include one or more data ingestion modules, secure data storage units, and processing engines for converting the raw data into a certain standardized and usable format more compatible with internal or external systems (e.g., electronic health record (EHR) systems, payer platforms, third-party billing systems, or any other healthcare-related systems). In some embodiments, health activity processed data 109 may be charge item data that may be used for billing or reimbursement, reporting data that may visualize progress or decline of one's health conditions, notification data, or any other data in a format different from raw data collected by healthcare application system 107. Charge item data may refer to structured billing artifacts generated by healthcare application system 107 to represent a billable milestone or event. Charge item may include attributes necessary for reimbursement workflows as discussed below with respect to FIG. 6. These attributes may be milestone identifier, date of service, charge amount, and associated CPT or ICD-10 codes. In some embodiments, charge item data may be encapsulated in a FHIR-compliant ChargeItem resource that can be transmitted to payer platforms or third-party billing systems. Reporting data may refer to artifacts to assist with visualizing progress or decline of a participant's health conditions. Notification data may refer to artifacts that will trigger alerts or reminders in healthcare application system 107. In some embodiments, health activity processed data 109 may be in a format compatible with Fast Healthcare Interoperability Resources (FHIR), a standard framework for exchanging electronic health records. The conversion of health activity raw data 105 to health activity processed data 109 may support clinical decision-making, facilitate billing and administrative functions, and enhance overall digital healthcare management efficiency. Health activity processed data 109 may be used to perform post processing activity 111.

Post processing activity 111 may refer to any secondary or downstream operation performed by healthcare application system 107 or an associated subsystem that uses health activity processed data 109 to generate outputs or transactions. In some embodiments, post processing activity 111 may include reporting operations that produce reports representing health trends, outcomes, adherence levels, or participation metrics. Such reports may be rendered through user interfaces accessible to participants, healthcare providers, payers, or other healthcare coordinators. In some embodiments, post processing activity 111 may include notification operations, in which healthcare application system 107 may generate and transmit alerts, reminders, or recommendations based on health activity processed data 109. In some embodiments, post processing activity 111 may include billing operations, where healthcare application system 107 may utilize health activity processed data 109 to identify chargeable items and determine reimbursable events. Upon identification of chargeable items, healthcare application system 107 may construct corresponding charge item data for billing operations.

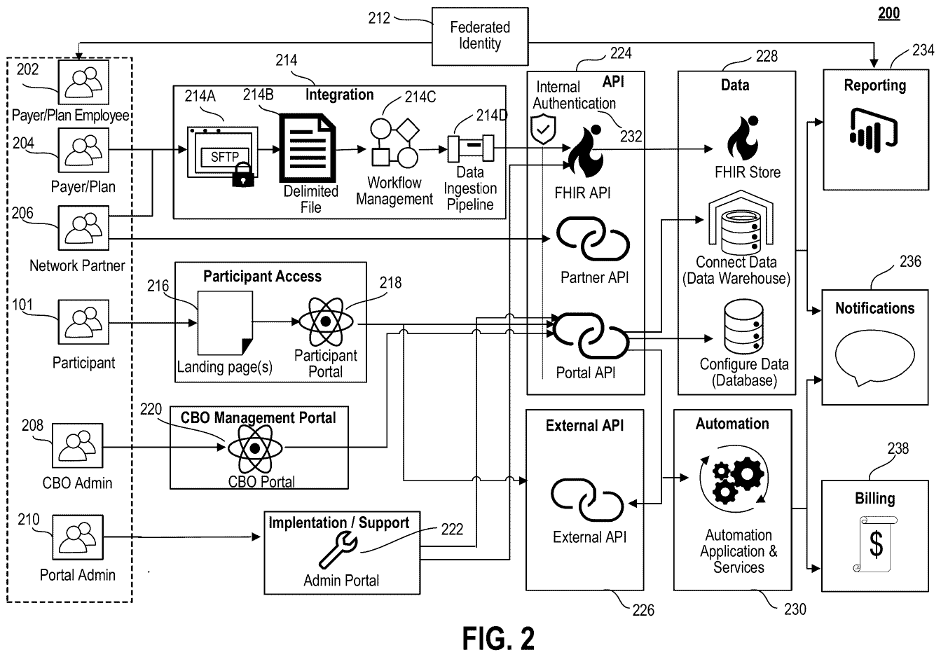

FIG. 2 illustrates an exemplary digital health management system 200, consistent with disclosed embodiments. System 200 may integrate various functional components that collectively enable the intake, processing, storage, retrieval, and management of healthcare data. In some embodiments, these components may include data integration channel 214, participant portal 218, community-based organizations (CBO) admin portal 220, admin portal 222, internal application programming interface (API) framework 224, external API framework 226, data storage component 228, and automation engine 230.

System 200 may engage multiple stakeholders in digital healthcare management, including payer employee 202, payer 204, network partner 206, participant 101, CBO administrator 208, and portal administrator 210. These multiple stakeholders may provide healthcare management data such as health activity data, eligibility data, group configuration data, enrollment data, health program contract information, clinical data and any other healthcare data relating to administration of digital healthcare management. In some embodiments, health activity data may include information directly or indirectly related to a healthcare participant's engagement with one or more digital health activities. Eligibility data may refer to information used to determine whether the participant is qualified to access certain digital health programs or services. Eligibility data may include participant demographic information, benefit status, plan start and end dates, qualifying conditions, or other payer-defined criteria. Group configuration data may define organizational structure and operational parameters associated with groups or cohorts of participants. Enrollment data may refer to records reflecting participant registration and activation in one or more digital health programs. Enrollment data may include participant identifiers, enrollment timestamps, program selections, participation status (e.g., active, pending, suspended, or terminated), and any other data related to participant registration and activation. Health program contract information may represent information defining the contractual relationships, terms, and performance obligations between stakeholders such as participants, payers, and healthcare service providers. Clinical data may refer to any data related to medical history, clinical statistics, diagnostic results, or ongoing treatment of participant. Collectively, these various data types may be stored, processed, and exchanged among authorized system components and stakeholders.

System 200 may be configured to collect healthcare-related data through one or more front-end applications, which may represent the user-facing components of the system designed to facilitate direct or indirect interaction with participants, payers, healthcare providers, or other healthcare stakeholders. The front-end applications may include web-based platforms, mobile applications, member or provider portals, content management systems (CMS), interactive dashboards, and other user engagement interfaces to collect data. In some embodiments, front-end applications may directly collect data from participants during their engagement in one or more digital health activities. For example, participant 101 may input self-reported data (e.g., dietary logs, activity updates, symptom assessments) through mobile or web interfaces or may connect compatible health monitoring devices (e.g., smart scales, wearable trackers, blood glucose monitors) to automatically transmit health activity data. In other embodiments, front-end applications may interface with third-party healthcare systems to collect data indirectly through these external systems. Third-party healthcare systems may include third-party digital health platforms, payer wellness systems, device manufacturer platforms, or other healthcare technology vendors that collect participant 101 health activity data through their own applications or devices. System 200 may process and convert the collected healthcare related data for post-processing activities, such as reporting, notifications, and billing.

Payer employee 202 may represent an individual associated with payer 204. Payer employee 202 may be an employee, plan member, or participant enrolled in a healthcare benefits plan sponsored by payer 204. In some embodiments, payer employee 202 may participate in one or more digital health programs or point solutions made available through her employer's healthcare plan. Payer employee 202 may interact with system 200 to view program content, submit health activity data, or receive personalized health insights and notifications. Payer 204 may refer to an employer, insurer, union, governmental agency, or other sponsoring entity responsible for financing, administering, and managing digital healthcare for its employees or members. Payer 204 may interact with system 200 through authorized interfaces or administrative portals to manage eligibility data, benefit configurations, group structures, outreach communications, and other plan administration functions.

Network partner 206 may represent an independent digital health solution provider or third-party service platform that offers specialized healthcare or wellness programs addressing specific or limited health domains via providing technological tools, devices, platforms, and systems that enable participant engagement, data collection, and other areas of digital health management. In some embodiments, network partner 206 may provide a digital health program focused on weight management, tobacco cessation, musculoskeletal (MSK) rehabilitation, diabetes management, or mental wellness.

Payer 204 and network partner 206 may supply and exchange data relating to administering of healthcare plan via data integration channel 214. Data integration channel 214 may represent a secure and structured communication framework that enables interoperability and data exchange among disparate systems, applications, and databases. Data integration channel 214 may be responsible for acquiring, transforming, and storing healthcare data. In some embodiments, data transmitted through data integration channel 214 may include eligibility data, enrollment data, group configuration data, clinical data, outreach information, and health activity data. In some embodiments, data integration channel 214 may include steps of uploading delimited files 214B, such as, for example, CSV, JSON, or XML records, of healthcare data. The files may be uploaded via Secure File Transfer Protocol (SFTP) 214A or other encrypted data exchange mechanisms to ensure data confidentiality and compliance with applicable privacy regulations such as the Health Insurance Portability and Accountability Act (HIPAA). In such embodiments, data integration channel 214 then may apply predefined series of processing operations to normalize and map the received data into FHIR-compatible data before forwarding to FHIR API through data ingestion pipeline. Workflow management 214C may ensure that data is properly sequenced, validated, and routed through the ingestion pipeline. Data integration channel 214 may include multiple steps, including data ingestion, validation, transformation, normalization, and/or any other data processing techniques, as data pass through data ingestion pipeline 214D.

A participant engaging in one or more digital health activities may interact with system 200 via participant portal 218, which may be accessed by landing page 216. Landing page 216 may be a user-friendly interface where the participant can engage with one-stop digital health management platform of system 200. In some embodiments, landing page 216 may provide authentication mechanisms, onboarding workflows, and intuitive navigation elements that guide participants toward relevant digital health programs, network partner services, and health management tools. Landing page 216 may display customized information based on participant identity, eligibility, or engagement history. After accessing participant portal 218, the participant may view, enroll in, and manage digital health programs that correspond to specific health conditions or wellness goals. Participant portal 218 may be configured to present a list of available network partners 206. In some embodiments, participant portal 218 may further enable participants to upload health activity data directly. Such uploads may include data files exported from wearable devices, mobile health applications, or personal monitoring tools. The uploaded data may undergo similar procedures in data integration channel 214 to ensure consistency with internal data models and interoperability standards.

CBO administrator 208 may represent an individual, organization, or authorized representative associated with a community-based organization (CBO) that manages healthcare-related programs and services for community members. For example, CBO administrator 208 may include case managers, program coordinators, or administrative staff responsible for overseeing enrollment, outreach, and service delivery for members participating in healthcare programs. CBO administrator 208 may utilize system 200 to manage a range of community health functions, including participant enrollment, eligibility verification, benefits management, and coordination of care across different service providers. CBO administrator 208 may access system 200 via a dedicated CBO portal 220. In some embodiments, CBO portal 220 may be a secure, web-based interface providing administrative tools and data visualization capabilities. Through CBO portal 220, CBO administrator 208 may also be able to verify service eligibility based on data such as insurance coverage, demographic information, or predefined benefit criteria. In some embodiments, CBO portal 220 may further support participant management, including tracking outreach campaigns, sending notifications, or monitoring care plan adherence. CBO portal 220 may also generate aggregate utilization reports to help CBO admin 208 to evaluate program effectiveness, resource allocation, and health outcomes within their managed populations.

Portal administrator 210 may refer to an individual, team, or authorized entity responsible for the overall configuration, maintenance, and operation of system 200. In some embodiments, portal administrator 210 may be part of an internal operations team, a managed service provider, or an external technology partner contracted to support system 200. Portal administrator 210 may perform administrative, technical, and supervisory functions necessary to ensure that all user-facing and back-end applications of system 200 operate reliably. Back-end applications may handle and process requests from user-facing applications, manage data, and perform business logic. Back-end applications may consist of a variety of services, including RESTful APIs, microservices, and other middleware components. Back-end applications may operate behind the scenes, providing the necessary infrastructure to support the user-facing applications. A user-facing application may call a back-end application to process data or to retrieve or access data. Portal administrator 210 may access system 200 through admin portal 222. Admin portal 222 may serve as a centralized control interface designed to facilitate system configuration, monitoring, and governance. Admin portal 222 may provide a suite of administrative tools, dashboards, configuration panels, or any other user interfaces that allow portal administrator 210 to perform a wide range of system management activities. To maintain data security and regulatory compliance, access to admin portal 222 may be restricted and governed by a comprehensive authentication and authorization framework.

System 200 may incorporate federated identity component 212 to enable secure and unified authentication across multiple organizations, systems, or domains. Federated identity component 212 may govern user authentication and access control by validating credentials against a centralized identity management framework. By employing federated identity architecture, system 200 may enable users (e.g., participants, payer employees, CBO administrators, network partner representatives, and portal administrators) to access its platform using a single, verified identity across various connected applications and service environments. Federated identity component 212 may govern authentication processes by validating user credentials against a centralized identity management framework or an external identity provider. This framework may facilitate single sign-on (SSO) functionality, allowing users to securely authenticate once and gain authorized access to multiple applications within system 200 without re-entering credentials for each subsystem. The federated identity model may rely on standardized authentication protocols including Security Assertion Markup Language (SAML), OpenID Connect (OIDC), OAuth 2.0, or any other identity solutions in compliance with industry security standards. In some embodiments, federated identity component 212 may be an identity and access management platform provided by Okta, Inc., but other systems or solutions may be utilized in other embodiments. Another security measure employed by system 200 may be internal authentication 232 processed through an API framework. In some embodiments, internal authentication 232 may be integrated with federated identity component 212. When a user attempts to access system 200 or one of its portals (e.g., participant portal 218, CBO portal 220, or admin portal 222), the authentication request may be securely transmitted via an API call to federated identity component 212.

System 200 may incorporate both internal API framework 224 and external API framework 226. These API frameworks may facilitate secure and structured data exchange between system 200 and other connected platforms, applications, or data repositories. These frameworks may enable system 200 to operate as an interoperable digital healthcare management system capable of exchanging data among various healthcare stakeholders while maintaining compliance with healthcare data protection and interoperability standards. Internal API framework 224 may facilitate integration of system 200 with internal network partner systems, authentication systems, payer data services, and governmental regulatory databases. In some embodiments, system 200 may integrate with FHIR API, which may enable secure exchange of structured healthcare data in compliance with interoperability standards for electronic health records and related digital health systems. Through this integration, health activity data, eligibility information, clinical data, and other program-related records may be shared between system 200 and external health systems using standardized resource definitions and exchange formats. In some embodiments, partner API may integrate system 200 with network partner systems, allowing network partner 206 to transmit and receive data directly with system 200. Partner API may enable secure data sharing including member enrollment, activity tracking, program outcome reporting, and other information necessary for digital healthcare management. In some embodiments, internal API framework 224 may further include portal API, which may serve as an intermediary communication layer between the user-facing portals (e.g., participant portal 218, CBO portal 220, and admin portal 222) and the back-end applications of system 200. External API framework 226 may facilitate integration of system 200 with third-party service providers, including reporting services, third-party notification systems, or financial services, or any other third-party systems may be integrated into digital healthcare management system. In some embodiments, external framework 226 may integrate system 200 with insurance billing APIs for healthcare businesses. Internal API framework 224 and external API framework 226 collectively provide a robust interoperability layer for system 200.

Collected digital healthcare data may subsequently be transferred to data storage component 228. Data storage component 228 may serve as a centralized or distributed storage environment responsible for the secure retention, indexing, and retrieval of all healthcare-related data utilized by system 200. For example, there may be a database in which data may be configured so that stored data are properly indexed, formatted, and readily accessible when system 200 requests for a certain operation. In some embodiments, data storage component 228 may include one or more operational databases. These databases may store active datasets generated by ongoing interactions between participants, payers, network partners, and administrators. For example, databases may maintain current participant profiles, health activity data, eligibility records, program configurations, and other healthcare information. In some embodiments, data storage component 228 may include a data warehouse configured to aggregate, organize, and analyze large volumes of structured and semi-structured healthcare data. These structured datasets may be stored for use in analytics, compliance tracking, or other activities that require large amount of data. The data warehouse may enable system 200 to generate insights, population-level analyses, and predictive modeling outputs by integrating time-series data such as health activity metrics, claims information, and program outcome data. In some embodiments, data storage component 228 may include FHIR Store, which may store healthcare management resources such as claim data, patient profiles, medication records, diagnostic observations, care plans, and encounter histories in standardized formats that enable interoperable exchange of data with external health information systems and EHR.

System 200 may incorporate an automation engine 230. Automation engine 230 may include programs that execute predefined workflows in healthcare such as claim processing, outreach and campaign management, billing management, eligibility verification, program enrollment, regulatory reporting, and other workflows required in healthcare-related businesses. Each workflow may be triggered by a predefined event or condition such as data ingestion, completion of a participant health activity, or receipt of claim data from payer or network partner systems. Automation engine 230 may function as a centralized orchestration component configured to execute rule-based and event-driven workflows within digital healthcare administration and digital health program management. Automation engine 230 may operate in close coordination with data storage component 228, retrieving relevant information from operational databases or data warehouses to support workflow execution. For example, automation engine 230 may access historical health activity data, clinical metrics, or member engagement history stored in data storage component 228 to determine eligibility criteria, outreach timing, or billing process initiation. In some implementations, automation engine 230 may include machine learning-based decision modules capable of dynamically optimizing workflows over time.

System 200 may include functionalities for post processing activities that generate actionable outputs according to health activity processed data, consistent with disclosed embodiments. These post processing activities may include reporting, notification, and billing operations, which may be carried out by corresponding systems. Reporting component 234 may provide comprehensive analytics and data visualization functionalities to authorized users. Reporting component 234 may enable users to generate reports reflecting health progress, program engagement, clinical outcomes, claim reimbursement history, or any other healthcare-related analytics and data visualization. Notification component 236 may manage the generation and delivery of notifications such as alerts, reminders, and informational messages to users. Notifications may include appointment reminders, prescription refill alerts, insurance policy updates, or program milestone achievements. In some embodiments, notification component 236 may utilize multi-channel delivery mechanisms such as email, SMS, push notifications, in-portal messages, or any combination thereof depending on user preferences or policy configurations. Billing component 238 may manage financial transactions associated with digital healthcare services. Billing component 238 may be responsible for generating, validating, and processing billing records derived from completed health activities, program participation milestones, or other healthcare related events. In some embodiments, billing component 238 may integrate with external insurance billing APIs through external API framework 226 to facilitate electronic claims submission and reimbursement processing. The post processing functionality of system 200 (e.g., reporting component 234, notification component 236, and billing component 23) may enable the system to transform raw and/or processed healthcare data into actionable outputs.

System 200 may execute a series of interconnected workflows designed to aggregate, process, and transform healthcare data into actionable and meaningful information. These workflows may be orchestrated by automation engine 230 and may involve coordinated interactions between data integration channel 214, data storage component 228, reporting component 234, and billing component 238. Through these workflows, disparate datasets (e.g., health activity data, eligibility information, clinical records) may be consolidated and analyzed to generate outputs including health reports, program performance summaries, and charge items for healthcare claim processing or billing.

FIG. 3 is a block diagram 300 illustrating an exemplary payer and network partner data integration of a digital health management system, consistent with disclosed embodiments. In some embodiments, the digital health management system (e.g., digital management health system 200) may be configured to process and integrate healthcare-related data from various external sources such as payers, network partners, and other healthcare entities. Payers and network partners may transmit multiple healthcare data files 301 including eligibility files, group configuration files, clinical data, outreach files, enrollment activity files, or health activity files to a digital management health system. Eligibility files may contain participant-level coverage details such as healthcare plan identifiers, coverage information, and benefit information. These files may enable the digital health management system to validate participant eligibility for different health programs. Group configuration files may define employer or payer group structures, including group identifiers and benefit configurations. The digital health management system may use these files to apply correct rules and pricing. Clinical data files may include biometric readings and diagnostic codes that support milestone evaluation and compliance. Outreach files may provide communication directives such as participant contact preferences and triggers for notifications and reminders. Enrollment activity files may track member enrollment status, program start and end dates, and disenrollment events to ensure accurate care plan management and billing practices. Health activity files may capture activity-level data. In some embodiments, health activity files may include exercise minutes, coaching sessions, and educational content accessed from network partners. The digital health management system may normalize inputs from these files and evaluate them against milestone templates to determine billable events. Milestone templates may refer to a predefined data structure representing achievement criteria, stages, or events relevant to a health program. In some embodiments, healthcare data files 301 may be in the form of structured, delimited files (e.g., CSV, TSV, XML, JSON, or other structured data formats); in other embodiments, healthcare data files may be in the form of unstructured text (e.g., ASCII-encoded text files). These data sets may be generated by the system or by partner systems and platforms. Healthcare data files 301 may be securely transmitted through internet gateway 303 utilizing Secure File Transfer Protocol (SFTP) 305. SFTP 305 may provide a secure communication channel to prevent unauthorized access and ensure data integrity during transmission. The SFTP layer may employ asymmetric encryption and public key authentication mechanisms to verify the identity of both sender and receiver prior to initiating file exchange. Other secure transfer protocols may be used to facilitate large-scale file transmission including File Transfer Protocol (FTP) over SSL/TLS, Secure Copy Protocol (SCP), or remote synchronization (rsync) over SSH.

Once the files enter the system, they may be stored in database 308 and may undergo one or more steps of decoding and processing through data ingestion pipeline. The received data may be decrypted via decrypt module 309. Decrypting module 309 may adopt appropriate cryptographic algorithms and key management mechanisms for each type of data files. The decryption process may ensure that sensitive healthcare data remains protected and accessible only to authorized system components in compliance with applicable data privacy regulations (e.g., HIPAA). Following the decryption, processing module 311 may process data to conform to FHIR-compliant data structure before further processing. The processing may include schema mapping, data type normalization, field validation, and semantic transformation to align data elements with standardized resource types. In some embodiments, after decryption and processing, the processed healthcare data may be converted into FHIR-compliant resources (e.g., Patient, Encounter, Observation, Claim, Coverage) using FHIR API 313. A Patient resource may represent the individual participating in a health program and may include demographic details, identifiers, and contact information. An Encounter resource may record interactions such as coaching sessions and may capture encounter type, date, and associated service provider. An Observation resource may store measurements or assessments. A Claim resource may represent the billing request submitted to a payer. A Coverage resource may contain insurance or benefit plan details, including payer information, plan identifiers, and coverage periods. FHIR API 313 may serve as an integration interface between the ingestion pipeline and the system's internal FHIR store 315. The FHIR API may handle the creation, updating, and retrieval of FHIR resources to ensure that all processed data conforms to interoperability standards for downstream operational uses. The ingestion process may record processing metrics and transactional details in an Electronic Data Interchange (EDI) metrics database 307. The digital health management system may transfer the FHIR-compliant records to data warehouse 317, where they are used to automate and optimize digital healthcare administrative processes by enabling large-scale analytics, reporting, automated billing, claim accuracy validation, and performance benchmarking across network partner programs.

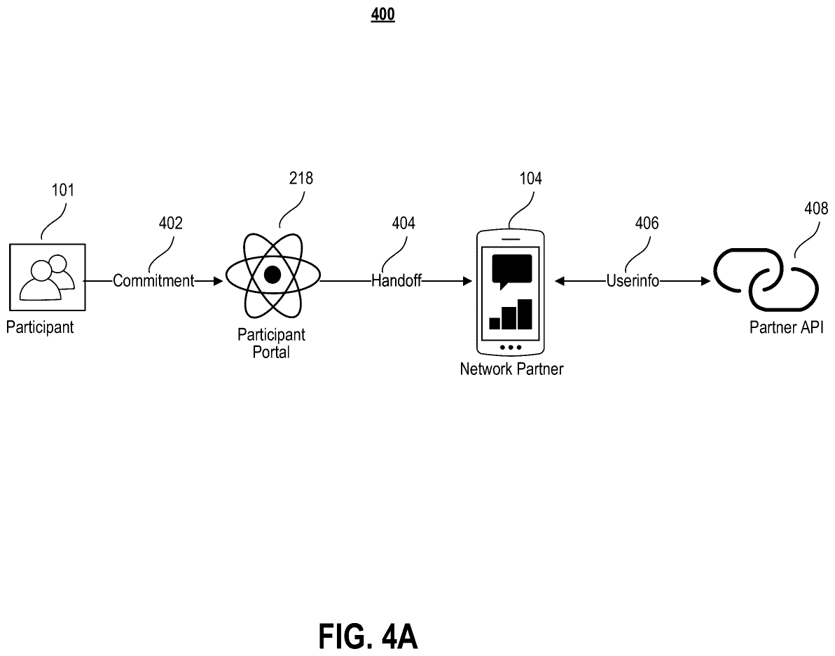

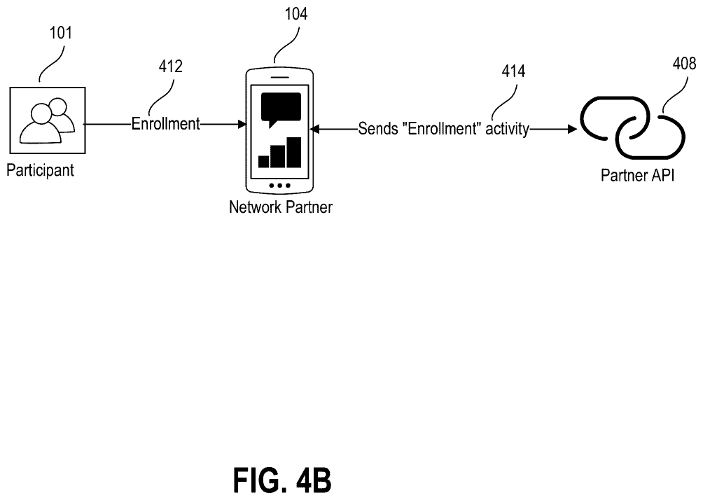

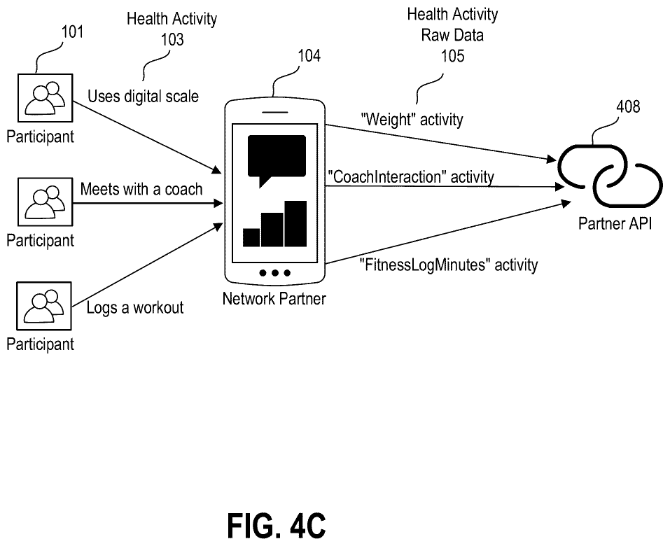

FIG. 4A is a block diagram 400 illustrating an exemplary participant commitment process, consistent with disclosed embodiments. When participant 101 selects network partner 104 to address a specific health condition or wellness goal, the participant may initiate a formal commitment through, for example, participant portal 218. Participant portal 218 may enable the participant to review program details, confirm consent, and electronically sign up with the selected network partner. Once the participant confirms commitment to the selected network partner, commitment data 402 may be logged into a database within the digital health management system, consistent with disclosed embodiments. Commitment data 402 may include participant identifiers, selected network partner information, timestamp, and associated program details. Following the commitment event, relevant user information such as participant name, age, demographic attributes, and unique participant identifier may be transmitted to the network partner through secure handoff 404. Secure handoff 404 may be performed using encrypted APIs or secure data exchange mechanisms to preserve data privacy and integrity. Upon receipt of user information 406, the network partner system may establish a communication interface with the digital health management system, consistent with disclosed embodiments. Through this interface, the network partner may subsequently transmit health activity data, engagement metrics, or care plan updates back to a digital health management system (e.g., system 200), consistent with disclosed embodiments, to enable continuous data synchronization and participant monitoring. The interface may be through partner API 408. Partner API 408 may refer to a standards-based application programming interface provided by the digital health management system, consistent with disclosed embodiments, that enables network partners to exchange data in real time.

FIG. 4B is a block diagram 410 illustrating an exemplary participant enrollment process 410, consistent with disclosed embodiments. Following the participant's commitment, as discussed above with respect to FIG. 4A, to engage with a selected network partner, participant 101 may proceed to enroll in one or more health programs offered by network partner 104. These programs may be designed to support improvement of the participant's specific health condition through various health activities as discussed below with respect to FIG. 4C. Enrollment 412 may represent a formalized health activity event that signifies participant 101's transition from initial registration to active program participation. Enrollment data may include program identifiers, enrollment timestamps, activity schedules, and any other participant engagement parameters for the selected programs. Once enrollment is confirmed, network partner 104 may generate and transmit enrollment activity data 414 to partner API 408 of the digital health management system, consistent with disclosed embodiments.

FIG. 4C is a block diagram 420 illustrating an exemplary member engagement process 420, consistent with disclosed embodiments. Once participant 101 participates in the health program of her choice, participant 101 may actively engage in one or more health activities 103 associated with the program. In some embodiments, health activities 103 may include capturing biometric data through connected devices (e.g., digital scales, blood pressure monitors, or fitness trackers), attending virtual or in-person coaching sessions, logging workouts, tracking nutrition, completing wellness assessments, or the like. Each of these activities may generate measurable health activity data that reflects the participant's engagement level and progress toward specific health goals. Health activities 103 may be structured and scheduled by the network partner's system and may occur continuously or at defined intervals throughout the duration of the program. Health activity data may be processed in real time or in batches, depending on network partner configuration, data volume, transmission frequency, and other factors. Network partner 104 may collect and pre-process health activity 103 data and subsequently transmit health activity raw data 105 to the digital health management system, consistent with disclosed embodiments, through partner API 408. Partner API 408 may serve as a standardized data exchange interface that enables real-time or batch transmission of data including health activity metrics, timestamps, and associated participant identifiers. Upon receipt, the digital health management system, consistent with disclosed embodiments, may validate and log the raw data into a designated data repository for further transformation and analysis.

FIG. 5 illustrates an exemplary data conversion process 500 of digital health management system, consistent with disclosed embodiments. Steps of process 500 may utilize various configurable parameters from different data sources and processing subsystems that collectively facilitate the translation of digital health activity data into billing events. Steps of process 500 may utilize multiple types of healthcare-related configuration data. In some embodiments, steps of process 500 may utilize parameters from partner mapping configuration 501, client program contract 503, and partner program contract 505. Partner mapping configuration 501 may define the data mappings, integration rules, and transformation logic required to normalize data received from external partner systems into a canonical data model used by the digital health management system, consistent with disclosed embodiments. Partner mapping configuration 501 may include lists of activity types (e.g., exercise sessions, coaching interactions, or educational modules), formula for converting partner-provided activity into standardized data, and data files containing participant engagement records. In some embodiments, Partner mapping configuration 501 may include network partner-specific activity names and values such as “CoachingInteractionsLogged,” “FitnessLogMinutes,” or “WeightLbs” and standardized activity names and values like “CoachInteraction,” “PhysicalActivity,” or “Weight.” Partner mapping configuration 501 may contain both textual and numeric values. Client program contract 503 may define the business, billing, and eligibility parameters associated with a specific client (e.g., participant) or client organization (e.g., employer or health plan purchaser). Client program contract 503 may include program identifiers, billing rates, thresholds for chargeable activity, eligible activity types, and rules governing when and how charges are generated. In some embodiments, client program contract 503 may include Program Code, Program Structure Code, details about program length, effective dates, and billing rates. It may also contain alphanumeric medical classification codes, including CPT and ICD-10 codes, that are associated with billable events within the program. Milestone definitions such as milestone names, descriptions, and achievement criteria may be also included. These parameters may be used by downstream billing processes. In some embodiments, client program contract 503 may include program identifier, program length, billing rate, medical classification or procedural codes associated with billable events in the program, and list of authorized network partners which may provide services for the given client program. Partner program contract 505 may define configuration data associated with each participating network partner that delivers program activities to participants. Partner program contract 505 may include descriptions of the kinds of health activities a network partner delivers, general criteria for what counts as a billable event, and lists of authorized services or reporting metrics used to track participant progress. Partner program contract 501 may contain both textual and numeric values. In some embodiments, partner program contract 505 may include program identifier, program length, and measurable health activity data that, when achieved, may generate billable events.

Steps of process 500 may utilize several functional subsystems responsible for processing and transforming incoming health activity data. In some embodiments, steps of process 500 may be performed by processing subsystems such as network partner mapping engine 507, assessment engine 509, and billing engine 511. Network partner mapping engine 507 may be configured to receive digital health activity data from one or more network partners. Each partner may transmit health activity data in a proprietary format. Network partner mapping engine 507 may utilize partner mapping configuration 501 to translate such partner-specific data into a canonical data format compatible with the system's internal data model. Upon receiving activity submissions, network partner mapping engine 507 may first validate that the submitting participant or network partner has the necessary authorization to access data related to the specified health programs. Network partner mapping engine 507 may load a partner-specific mapping module, a software module configured to interpret and process the unique data elements, schemas, and formats associated with a particular network partner. Network partner mapping engine 507 may operate based on the rules and definitions specified in partner mapping configuration 501. When network partner mapping engine receives activity submissions from network partner 104, it loads the relevant partner mapping configuration 501, which may include mapping rules, schema definitions, and validation criteria, to interpret and process the incoming data. The partner-specific mapping module may perform several operations including schema validation, content validation, and range validation of health activity data submission. After successful validation, the partner-specific mapping module may map the network partner's proprietary data fields and values into the canonical data model of the digital health management system, consistent with disclosed embodiments. The transformed data may then be stored within FHIR store 315 (e.g., FHIR-compliant healthcare database). In some embodiments, the transformed data may include standardized health activity records such as FHIR Observation resources (e.g., normalized exercise sessions, coaching interactions, biometric measurements), CarePlan resources (e.g., data linking participants to specific programs), and ChargeItem resources (e.g., data representing billable milestones or events). After mapping and validation, health activity data from health activity 103 may be transmitted to and processed by assessment engine 509. In some embodiments, assessment engine 509 may be also called a milestone engine. Assessment engine 509 may be configured to evaluate participant health activity data, determine the achievement of defined milestones or health goals, and generate corresponding charge items that can be billed via claims or invoices within the digital health management system, consistent with disclosed embodiments. In some embodiments, the term “milestone” may mean an achievement specific to a health program that the participant is engaging in. Each milestone may represent a defined stage, event, or accomplishment associated with participant engagement, adherence, or outcome metrics as established by client program contract 503 and/or partner program contract 505. Assessment engine 509 may evaluate participant health activity data against a library of milestone templates. Milestone templates may refer to a predefined data structure representing achievement criteria, stages, or events relevant to a health program. By evaluating health activity data against the library of milestone templates, assessment engine 509 may identify an observed activity pattern. An observed activity pattern may refer to a combination or sequence of health activities within healthcare data set that matches the achievement criteria specified in one or more milestone templates. In some embodiments, observed activity patterns may be defined by program specific milestone templates. As one example, in an IBC-based weight management program, an observed activity pattern may comprise a six milestone pay-for-performance schedule. The schedule, in some embodiments, may include enrollment, engagement, outcome, and maintenance phases. The digital health management system, consistent with disclosed embodiments, then may release full payment to appropriate network partners only after a participant completes all six milestones as defined by the program's pay-for-performance structure.

As another illustrative example, in an SMBP hypertension program, a combination of meaningful engagements, such as logging home blood pressure readings, engaging with disease management content, and logging meals, may trigger an observed activity pattern that matches a milestone template that generates a claim. Each individual health activity 103 may not be billable or chargeable on its own, but it may contribute toward a billable milestone as a part of the required combination and sequence of activities defined by milestone templates. When the combination of health activities are aggregated and mapped according to one or more milestone templates, health activities may collectively form a milestone that is recognized by steps of process 500 as billable or chargeable. This approach may enable steps of process 500 to translate a series of non-billable events into a clinically meaningful milestone that can be processed for billing and claim generation.

In some embodiments, assessment engine 509 may perform a sequence of operations including identification and queuing of specific health programs, loading health activity data, loading client program and partner program contract parameters, specified achievement determination, and generation of charge items and billing instructions. Generated billing instructions and charge items may include charge identification, charge amount, medical classification codes, and any other information necessary for claims processing. In some embodiments, the generated billing instruction may be a standardized electronic claim formatted according to the EDI-837 specification, ensuring compatibility with industry-standard electronic data interchange protocols for healthcare claims submission. The EDI-837 specification may refer to a standardized electronic data interchange (EDI) format used in the healthcare industry for submitting medical claims to payers, such as insurance companies or government programs. Assessment engine 509 may ensure that participant engagement and progress are consistently measured and monetized according to defined contractual and regulatory frameworks. Upon identifying an observed activity pattern, assessment engine 509 may convert the observed activity pattern into an electronic record. An “electronic record” may refer to a structured digital representation of the participant's achievement, electronically formatted for interoperability and downstream processing.

The generated billing instructions and charge items may then be transmitted or queued for processing by billing engine 511. Billing engine 511 may convert charge items into a formal claim, invoice, or electronic billing record in compliance with healthcare billing standards and payer requirements. Billing engine 511 may interface with internal or external billing systems to ensure accurate claim and invoice processing and network partner payment. Billing engine 511 may include modules such as healthcare claim submission 513, claim payment 515, and network partner payout 517. In healthcare claim submission 513, billing engine 511 may prepare and submit charge items for reimbursement in accordance with the generated billing instructions. In some embodiments, data from charges items may include member ID, milestone name, charge amount, CPT and ICD-10 codes, and charge item ID. The member ID may identify participant 101 associated with the charge. The milestone name may specify the particular achievement or stage reached in the health program by participant 101. The charge amount may indicate the monetary value to be billed for the milestone. CPT and ICD-10 codes may provide standardized medical and procedural classifications for billing and claims processing. The charge item ID may serve as a unique identifier for tracking and referencing the specific charge. In another embodiments, billing engine 511 may prepare and submit claims for reimbursement to the appropriate payer in the EDI-837 format. Billing engine 511 may assemble and transmit the claim to the appropriate payer (e.g., insurer or employer). Billing engine 511 may transmit claims electronically in compliance with payer-specific billing requirements. When payer 204 processes and pays the submitted claim, claim payment 515 may initiate. Billing engine 511 may receive a claim payout notification from payer 204 or third-party claims processor. Upon receipt, the status of the submitted claim may be updated to “paid.” Once payer payment has been confirmed, network partner payout 517 may start. Billing engine 511 may queue all paid charge items associated with network partners awaiting reimbursement. These charge items then may be exported to network partner payout 517. During network partner payout 517, a digital healthcare management system (e.g., system 200) may review and approve each charge item automatically, leading to appropriate payment to corresponding network partners.

In some embodiments, billing engine 511 may maintain a payout queue all paid charge items associated with network partners awaiting reimbursement in data storage component 228. In some embodiments, billing engine 511 may export the queued charge items, which reference the charge item ID, member ID, milestone name, payment amount, and other necessary metadata, to network partner payout 517. Network partner payout 517 may execute a structured settlement workflow for validating partner eligibility and contract terms, applying payment rules (e.g., holdbacks, minimum thresholds, proration, or clawback), and computing the net payout for network partner 104. Network partner payout 517 may then authorize disbursement by posting payment instructions to an integrated payments service. This end-to-end sequence may ensure that payment is driven by verifiable data, contract-aware calculations, and traceable system events.

FIG. 6 illustrates an exemplary participant data integration for billing process 600, consistent with disclosed embodiments. Steps of process 600 may implement an API-driven data exchange and conversion framework designed to facilitate interoperability among multiple internal and external components. The framework may include multiple APIs including portal API 605 for participant portal 218 and partner API 408, consistent with disclosed embodiments, that collectively enable secure and seamless data flow between the user-facing interfaces, internal processing modules, network partner systems, and other third-party systems. Portal API 605 may be a secure, system-provided API that exposes endpoints to participant portal 218 for operations such as account access, consent and enrollment, activity submission/retrieval, progress reporting, and milestone notification delivery. In some embodiments, these APIs may be managed by API framework 224, which may serve as an orchestration layer that coordinates the multiple API endpoints. API management framework 224 may provide centralized control over portal API 605 and partner API 408 to handle routing to internal services and perform checks so that all API calls are authenticated, authorized, and delivered to the correct processing modules. These APIs may employ secure communication to ensure reliable data transactions.

In some embodiments, a participant may select a network partner through the participant portal to assist in managing one or more of her health conditions, such as diabetes, digestive health issues, hypertension, mental health issues, musculoskeletal (MSK) issues, tobacco use problems, weight management, and women's health. During the engagement, participant 101 may provide health activity data such as measurements, completed sessions, or other health-related information to network partner 104. Upon submission, incoming health activity data from multiple participants may be temporarily stored in activity data queue 602. Activity data queue 602 may be a managed queue designed to temporarily buffer data from multiple concurrent participant sessions. Additionally, activity data queue 602 may act as a buffer to regulate data flow and prevent processing bottlenecks during high-volume data transmissions. Queued data may then be retrieved and processed by partner data processor 604. Upon retrieving queued submissions, partner data processor 604 may apply partner-specific mappings, schema constraints, and validation criteria from partner mapping configuration 501, and may utilize the canonical field mappings output by network partner mapping engine 507. Partner data processor 604 may execute a series of validation, parsing, and transformation routines to convert the raw data into a structured format compliant with the FHIR specification. The converted FHIR-compliant data may be securely stored in FHIR Store 315 for retention and future retrieval.

Steps of process 600 may comprise transferring the stored FHIR data to data warehouse 317, where it aggregates and utilizes the data for post-processing activities. In some embodiments, steps of process 600 may comprise designating portions of the stored data for billing purposes and route the relevant data to assessment check 606. Assessment check 606 may evaluate whether the available data satisfies predefined criteria for a charge item generation (e.g., service completion, milestone achievement, or any other clinical threshold met). Assessment check 606 may involve rule-based and/or artificial intelligence (AI) driven logic to validate billing eligibility. Nightly trigger 608 may execute scheduled batch assessments on accumulated data intended for billing review. Data validated through this process may then be placed into assessment queue 610, which serves as a temporary repository for verified participant health activity data awaiting financial processing.

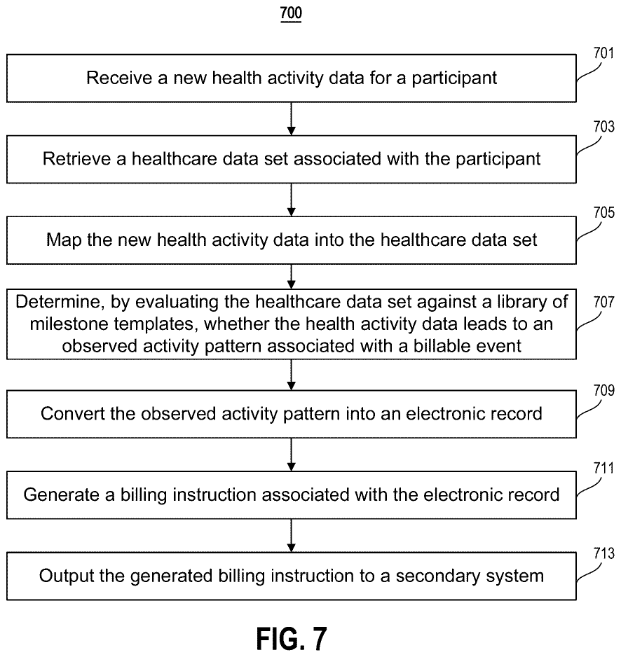

FIG. 7 is a flow diagram illustrating an exemplary method 700 of converting digital health activity data into a charge item for billing, consistent with disclosed embodiments. Method 700 may be practiced on computing device 800. Method 700 may be used to manage digital health.

Method 700 may include a step 701 of receiving a new health activity data for a participant. As discussed above with respect to at least FIG. 1, the new health activity data may include records such as exercise completion, weight or blood pressure measurements, educational content engagement, remote patient monitoring results, or any other health records for managing one's health. The received new health activity data may be temporarily stored in a secure staging area pending validation and mapping.

Method 700 may include a step 703 of retrieving a healthcare data set associated with the participant. Upon receiving the new activity data, the participant's existing healthcare data set from a database may be retrieved as discussed above with respect to at least FIG. 1. This healthcare data set may include participant identifier, health program associated with the participant, eligibility associated with the participant, group configuration associated with the participant, enrollment associated with the participant, health program contract associated with the participant, or past health activity data associated with the participant.

Method 700 may include a step 705 of mapping the new health activity data into the healthcare data set. The mapping process may be executed by a network partner mapping engine, as discussed above with respect to at least FIG. 5, using configuration parameters defined in partner mapping configuration information. In some embodiments, mapping may comprise the following sub-steps: validating data schema, field content, and a data range of the new health activity; converting the new health activity data into a standardized format to enable interoperability; and loading the converted new health activity data into the healthcare data set to generate combined health activity data including the past health activity data and the converted new health activity data. Schema validation may ensure that all required fields are present (e.g., participant identifier, activity type, timestamp, metric value), that field values match expected data types (e.g., numeric, categorical), and that numeric values fall within acceptable ranges defined by the mapping configuration or program rules. Converting the new health activity data may apply one or more transformation algorithms to translate the network partner's proprietary data structure into a canonical data model compatible with the digital health management system, consistent with disclosed embodiments. Once converted, the activity data may be loaded and stored in the participant's healthcare data set within the system's database as discussed above with respect to at least system 200. In some embodiments, the system's database may be a FHIR-compliant database.

Method 700 may include a step 707 of determining, by evaluating the healthcare data set against a library of milestone templates, whether the combined health activity data in the healthcare data set leads to an observed activity pattern associated with a billable event. This determination may be performed by an assessment engine, as discussed above with respect to at least assessment engine 509 in FIG. 5, which may evaluate the combined health activity data against the rules and achievements specified in health program contracts. For example, the system may determine that the participant has completed the required number of health activities over a defined timeframe, and the system may recognize the occurrence of a billable event based on the participants completion of required health activities.

Method 700 may include a step 709 of converting, if the combined health activity data in the healthcare data set led to the observed activity pattern, the observed activity pattern into an electronic record. As discussed above with respect to at least FIG. 5, this process may involve extracting relevant activity metrics and achievement details from the healthcare data set and assembling them into an electronic record. The electronic record may be structured to capture the specifics of the participant's engagement and milestone attainment to ensure that all necessary data elements are included for subsequent billing and reporting operations.

Method 700 may include a step 711 of generating a billing instruction associated with the electronic record. When a specified achievement in a health program contract has been achieved, the system may retrieve billing parameters from healthcare contracts with service providers and network partners to generate a billing instruction. The retrieved billing data may include program identifying the specific health program, billing rate for the specified achievement, medical classification codes, and network partner identifier. In some embodiments, the generated billing instruction may be a standardized electronic claim formatted according to the EDI-837 specification, The parameters from the retrieved billing data may be used to construct a standardized billing record that links the participant's achievement to the appropriate contractual billing structure. The billing instruction may include a charge identification, a charge amount, and a medical classification code. This step may be performed by an assessment engine in cooperation with a billing engine.

Method 700 may include a step of 713 of outputting the generated billing instruction to a secondary system. As discussed above with respect to at least FIG. 5, a billing engine may receive the billing instruction and queue it for claim generation and submission to external payer systems or network partner platforms. The billing engine may actively monitor the status of submitted claims, and may track updates from payers regarding adjudication and payment. Upon confirmation of claim payment, the billing engine may trigger partner payment processes to process reimbursement for billable events.

Embodiments described herein may refer to methods that include various steps. Unless the order is characterized as necessary, the steps of methods described herein may be performed in any order possible to achieve the results of the method.

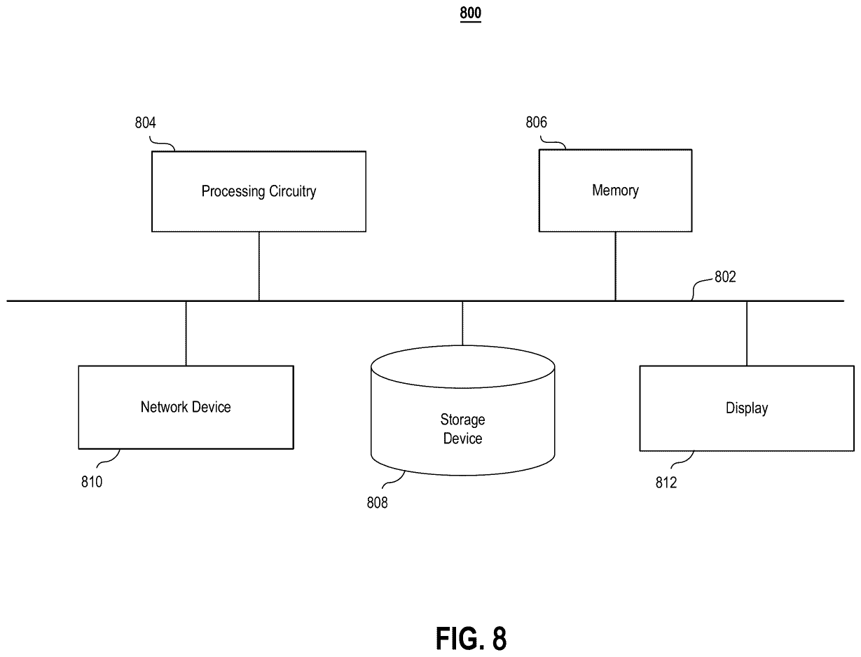

FIG. 8 is a block diagram illustrating an exemplary computing device 800 designed to assist digital health management is depicted. The computing device 800 may include processor 804, such as, for example, a central processing unit (CPU). A CPU may be a hardware component responsible for executing instructions of a computer program. The CPU may perform arithmetic and logic operations, manage data storage and retrieval, and control input and output devices.

In some embodiments, processor 804 may include, or may be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), application-specific integrated circuit (ASIC), controllers, state machines, gated logic, discrete hardware components, dedicated hardware finite state machines, and/or ), a server, a virtual server, or other circuits suitable for executing instructions or performing logic operations. In some embodiments, processor 804 may include more than one processor. Processors in the more than one processor may be separate circuits or integrated in a single circuit. When more than one processor is used, the processors may be configured to operate independently or collaboratively and may be co-located or located remotely from each other. The processors may be coupled electrically, magnetically, optically, acoustically, mechanically or by any other means that permit them to interact. The processor such as processor 804 may be coupled via bus 802 to memory 806.

A microprocessor may be a central processing unit designed for general-purpose computing tasks. A microcontroller may be a compact integrated circuit containing a processor core, memory, and input/output peripherals, which may be used for embedded systems and specific control applications. Digital signal processors, (DSPs) may refer to a specialized microprocessor, which may be designed for executing digital signal processing tasks. DSPs may process and manipulate digital signals for applications such as audio and video processing, telecommunications, and signal analysis. A field programmable gate array (FPGA) may be a programmable integrated circuit (IC) configured to be programmed after manufacturing. A FPGA may be a customizable digital logic circuit configured to perform specific tasks or functions. A FPGA may be reconfigurable for a wide range of applications. A bus may refer to a communication pathway or set of conductors that may enable multiple components or devices to exchange data and signals within the circuit.

Memory 806 may further include a memory portion that may contain instructions that when executed by processor 804, may perform the methods described in more detail herein. Memory 806 may be further used as a working scratch pad for processor 804, a temporary storage, and others. Memory 806 may be a volatile memory such as, but not limited to, random access memory (RAM), and/or non-volatile memory (NVM), such as, but not limited to, flash memory. In some embodiments, memory 806 may include a Read-Only Memory (ROM), a hard disk, an optical disk, a magnetic medium, other permanent, fixed, or volatile memory, or any other mechanism capable of storing instructions. As used herein, a memory may be any type of physical memory in which information or data readable by at least one processor may be stored. Examples of memory also include hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same. The term “memory” (e.g., memory 806) may refer to multiple structures, such as a plurality of memories or computer-readable storage media located within an input unit or at a remote location. Additionally, one or more computer-readable storage mediums may be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors (e.g., processor 804) or as a temporary storage. Accordingly, the term computer-readable storage medium should be understood to include tangible items and exclude carrier waves and transient signals. Processor 804 may be further connected to network device 810, such as a network interface card (NIC), for providing connectivity between the computing device 800 and a network. A NIC may be a hardware component that enables a computer or other device to connect to a network, providing a physical interface for the transmission and reception of data over the network. Processor 804 may be further coupled with a storage device 808. The coupling may be through bus 802.

Storage device 808 may be used for storing a wide variety of data, including but not limited to single data type column-oriented data structures, complex multi-type data structures, individual data elements, metadata, configuration files, logs, images, documents, and any other digital content relevant to the operation of the digital health management system, consistent with disclosed embodiments. Storage device 808 may be a generic or specific electronic device capable of storing codes and data accessible by processor 804 (e.g., via bus 802). For example, storage device 808 may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (“apps”) for specific tasks. While illustrated in FIG. 8 as a single device, it is to be understood that storage device 808 may include multiple devices either collocated or distributed. Storage device 808 may also be a virtual memory that includes one or more storage devices distributed across multiple machines or devices coupled via a network. Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of system 800, a component of storage 808, or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

As shown in FIG. 8, computing device 800 may include display 812. Display 812 may be a computer screen, a phone screen, a tablet screen, interactive display, augmented reality (AR), virtual reality (VR) display, or any other structure capable of displaying data. Display 812 may include a user interface, such as a computer with a keyboard and mouse, or a touch screen.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor (e.g., processor 804). It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor, cause the at least one processor to perform a method. Non-transitory computer readable mediums may be any medium capable of storing data in any memory (e.g., memory 806) in a way that may be read by any computing device with a processor to carry out methods or any other instructions stored in the memory. The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”) (e.g., processor 804), a memory (e.g., memory 806), a database (e.g., storage 808), a network device (e.g., network device 810), and output (e.g., display 812). The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium may be any computer readable medium except for a transitory propagating signal.

Processor 804 may run computer applications. Applications may include mobile computer programs configured to run on mobile phones or tablet computers. Applications may also be computer programs configured to run on laptop computers or desktop computers. Computer applications are computer software packages designed to carry out specific tasks. Some applications may be front-end applications that interact directly with of a computer or mobile device user. Processor 804 may run front-end applications. Back-end applications may handle and process requests from front-end applications, manage data, and perform business logic. Back-end applications may consist of a variety of services, including RESTful APIs, microservices, and other middleware components. Back-end applications may operate behind the scenes, providing the necessary infrastructure to support the user-facing elements of front-end applications. A front-end application may call the back-end application to process data or to retrieve or access data. Processors communicating with network device 810 may, for example, run back-end applications.

As a whole, the disclosed systems and methods may provide an omni-condition digital health management system that integrates a variety of healthcare point solutions into a single, user-friendly interface. The disclosed systems and methods may provide improvements for managing digital health because they may allow reduction of administrative burdens and cost savings by streamlining the management of point solutions for digital health activities. Additionally, a single platform for managing digital health activities allows for seamless data collection, processing, and conversion to ensure participants can engage in health activities while maintaining compliance with industry standards (e.g., FHIR). This integration of technologies for managing multitude of point solutions via network partners not only improves user experience but also addresses inefficiency and ineffectiveness of researching, managing, and measuring point solutions separately in healthcare management.

The disclosed embodiments are not limited to the above-described examples, but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods maybe modified in any manner, including by reordering steps or inserting or deleting steps.

It is intended, therefore, that the specification and examples be considered as examples only, with a true scope and spirit being indicated by the following claims and their full scope of equivalents.

What is claimed is:

1. A system for managing digital health activities, the system comprising:
a memory storing instructions; and
at least one processor configured to execute the instructions to:
receive, from a participant device, a new health activity data for a participant;
retrieve a healthcare data set associated with the participant, wherein the healthcare data set includes:
a participant identifier; and
past health activity data associated with the participant;
map the new health activity data into the healthcare data set, wherein the mapping comprises:
validating data schema, field content, and a data range of the new health activity;
converting, using at least one transformation algorithm, the new health activity data into a standardized format to enable interoperability; and
loading the converted new health activity data into the healthcare data set to generate combined health activity data including the past health activity data and the converted new health activity data;
determine, by evaluating the healthcare data set against a library of milestone templates, whether the combined health activity data in the healthcare data set leads to an observed activity pattern associated with a billable event;
if the combined health activity data in the healthcare data set leads to the observed activity pattern:
convert the observed activity pattern into an electronic record;
generate a billing instruction associated with the electronic record; and
output the generated billing instruction to a secondary system.

2. The system of claim 1, wherein the healthcare data set further includes: a health program associated with the participant, eligibility associated with the participant, a group configuration associated with the participant, enrollment associated with the participant, or a health program contract associated with the participant.

3. The system of claim 1, wherein the generated billing instruction includes a charge identification, a charge amount, and a medical classification code.

4. The system of claim 3, wherein outputting the generated billing instruction further comprises:
associating the charge identification and the healthcare data set;
generating a claim object, the claim object comprising data elements extracted from the healthcare data set and the generated billing instruction;
publishing the claim object to a third-party payer system;
monitoring whether the charge amount has been received by the third-party payer system; and
initiating, upon confirmation of receipt of the charge amount, a payout process to a network partner system.

5. The system of claim 1, wherein determining whether the combined health activity data in the healthcare data set leads to an observed activity pattern associated with a billable event further comprises:
retrieving milestone achievement criteria associated with a plurality of milestone templates in the library of milestone templates, each milestone template being stored as a data structure associated with a health program contract associated with the participant;
assessing, using a rule-based assessment engine, the combined health activity data in the healthcare data set against the plurality of milestone templates by mapping the retrieved milestone achievement criteria against the healthcare data set;
determining, based on the assessing, whether the milestone achievement criteria in at least one milestone template have been satisfied;
if the milestone achievement criteria have been satisfied:
generating a milestone object, the milestone object comprising metadata linking the combined health activity data and the healthcare data set; and
updating a satisfaction status associated with the milestone object.

6. The system of claim 1, wherein the generated billing instruction is a standardized electronic claim formatted according to the EDI-837 specification.

7. The system of claim 1, wherein the standardized format to enable interoperability comprises a Fast Healthcare Interoperability Resources (FHIR) framework.

8. The system of claim 1, wherein the secondary system comprises a third-party payer system and a network partner system.

9. The system of claim 1, wherein the instructions further comprise to utilize an external interface configured to enable retrieval of participant information and submission of the new health activity data for processing.

10. The system of claim 9, wherein the external interface is configured to enforce security protocols prior to accepting the new health activity data.

11. The system of claim 1, wherein the mapping further comprises utilizing a network-partner-specific mapping module configured to support data elements and formats associated with the network partner.

12. The system of claim 1, wherein the mapping further comprises converting network-partner-specific health activity names into standardized health activity names according to a canonical data model.

13. The system of claim 1, wherein upon determining that the combined health activity data in the healthcare data set leads to the observed activity pattern, the processor is configured to execute the instructions to generate a milestone object and a charge item based on the observed activity pattern, the milestone object and charge item being formatted in accordance with the Fast Healthcare Interoperability Resources (FHIR) framework.

14. A method for managing digital health activities, the method comprising:
receiving, from a participant device, a new health activity data for a participant;
retrieving a healthcare data set associated with the participant, wherein the healthcare data set includes:
a participant identifier; and
past health activity data associated with the participant;
mapping the new health activity data into the healthcare data set, wherein the mapping comprises:
validating data schema, field content, and a data range of the new health activity;
converting, using at least one transformation algorithm, the new health activity data into a standardized format to enable interoperability; and
loading the converted new health activity data into the healthcare data set to generate combined health activity data including the past health activity data and the converted new health activity data;
determining, by evaluating the healthcare data set against a library of milestone templates, whether the combined health activity data in the healthcare data set leads to an observed activity pattern associated with a billable event;
if the combined health activity data in the healthcare data set leads to the observed activity pattern:
converting the observed activity pattern into an electronic record;
generating a billing instruction associated with the electronic record; and
outputting the generated billing instruction to a secondary system.

15. The method of claim 14, wherein the healthcare data set further includes: a health program associated with the participant, eligibility associated with the participant, a group configuration associated with the participant, enrollment associated with the participant, or a health program contract associated with the participant.

16. The method of claim 14, wherein the generated billing instruction includes a charge identification, a charge amount, and a medical classification code.

17. The method of claim 16, wherein outputting the generated billing instruction further comprises:
associating the charge identification and the healthcare data set;
generating a claim object, the claim object comprising data elements extracted from the healthcare data set and the generated billing instruction;
publishing the claim object to a third-party payer system;
monitoring whether the charge amount has been received by the third-party payer system; and
initiating, upon confirmation of receipt of the charge amount, a payout process to a network partner system.

18. The method of claim 14, wherein determining whether the combined health activity data in the healthcare data set leads to an observed activity pattern associated with a billable event further comprises:
retrieving milestone achievement criteria associated with a plurality of milestone templates in the library of milestone templates, each milestone template being stored as a data structure associated with a health program contract associated with the participant;
assessing, using a rule-based assessment engine, the combined health activity data in the healthcare data set against the plurality of milestone templates by mapping the retrieved milestone achievement criteria against the healthcare data set;
determining, based on the assessing, whether the milestone achievement criteria in at least one milestone template have been satisfied;
if the milestone achievement criteria have been satisfied:
generating a milestone object, the milestone object comprising metadata linking the combined health activity data and the healthcare data set; and
updating a satisfaction status associated with the milestone object.

19. The method of claim 14, wherein the standardized format to enable interoperability comprises a Fast Healthcare Interoperability Resources (FHIR) framework.

20. The method of claim 14, where in the mapping further comprises converting network-partner-specific health activity names into standardized health activity names according to a canonical data model.
